(19) United States
(12) Patent Application Publication
(10) Pub. No.: US 2011/0086225 A1
(43) Pub. Date: Apr. 14, 2011

(54) FLAME-RETARDANT SPUN-DYED POLYSETE FIBER, FLAME- RETARDANT MATERIAL COMPRISING THE SAME, AND PROCESS FOR PRODUCING FLAME-RETARDANT SPUN-DYED POLYESTER FIBER

(75) Inventors: Noriaki Takagi, Aichi (JP); Hiroyuki Mishima, Aichi (JP); Satoshi Yanagisawa, Aichi (JP); Kazuo Matsuyama, Okazaki-shi (JP)

(73) Assignee: TAKAGI CHEMICALS, INC., Okazaki-shi, Aichi (JP)

(21) Appl. No.: 12/918,485

(22) PCT Filed: Jul. 2, 2009
(86) PCT No.: PCT/JP2009/062147

§ 371 Date: Oct. 27, 2010

(30) Foreign Application Priority Data
Jul. 4, 2008 (JP) 2008-176162

(51) Int. Cl. C08K 3/32; C08K 5/23; C08K 5/08; C08K 5/3437; C08K 5/3417; D02G 3/00

(52) U.S. Cl. 428/401; 524/414; 524/416; 524/190; 524/358; 524/90; 524/88; 524/415

(57) ABSTRACT

[Problem]

A method by which a flame proofing property can easily be provided to polyester fiber having long-term stable color and excellent mechanical properties, particularly, a resin composition and a flame proofing method needed for flame retardant spun-dyed polyester fiber which is excellent in light resistance and durability, and is capable of coloring any of various colors, and also, is environment-friendly, are strongly desired.

□Solution□

There is provided a flame retardant spun-dyed polyester fiber obtained by melt-spinning a flame retardant polyester resin composition comprising a flame retardant comprising at least one inorganic phosphorus-nitrogen based compound selected from the group consisting of ammonium polyphosphate, melamine polyphosphate and phosphazenes; colorant; and thermoplastic polyester resin, characterized in that content of said inorganic phosphorus-nitrogen based compound is 0.1 to 12% by mass, content of said colorant is 0.01 to 5% by mass, and content of said thermoplastic polyester resin is 83 to 99.89% by mass, based on the total weight of said polyester resin composition. Particularly, when disposed polyester is used as the thermoplastic polyester resin, it contributes to material recycle as well.

### TECHNICAL FIELD

The present invention is related to provide a flame retardant spun-dyed polyester fiber compounded a mixture of inorganic phosphorus-nitrogen based compound and inorganic red phosphorus as a main component of flame retardant, flame retardant material using the same, and a process for producing the flame retardant spun-dyed polyester fiber.

### BACKGROUND ART

Thermoplastic polyester, particularly, polyethylene terephthalate (PET) is excellent in a balance such as mechanical properties, heat resistance, moldability, chemical resistance, and is inexpensive, therefore, it has a significantly wide application use as molding and packaging material represented as fiber, film, and PET bottle. Further, in recent years, from the viewpoint of reuse of resources, polyester resin after use or polyester resin obtained from recovery of polyester waste generated in molding process, has been reused as a raw materials for fiber or PET bottle. However, in the increase of such demand, thermoplastic polyester has a weak point of easy combustibility, and further, in recent years, by increasing recognition for fire and environment, environmentally-friendly flameproofing technology alternative to halogen type flame retardant is strongly desired.

Heretofore, various trials for flameproofing the polyester fiber have been carried out, various methods such as a method of using copolymerized polyester obtained by copolymerization with flame retardant; a method of kneading flame retardant into polyester and spinning it; a method of flameproofing a recycled polyester; a method of flameproofing a textile product by after-processing, have been proposed. On the other hand, as for the flame retardant resin composition, various proposals are reported, however, it is reported that the expression of flame retardant performance is wide-ranging.

For example, Patent document 1 discloses the method of producing flame retardant recycle polyester fiber obtained by spinning, or spinning and stretching with using the raw material, mixed copolymerized polyester obtained by copolymerization of the organic phosphorus compound and recovered polyester.

In addition, Patent document 2 discloses flame retardant recycled spun-dyed polyester fiber obtained by melt blending and spinning fibrously the recycled polyester resin having 1.0 to 1.4 of intrinsic viscosity obtained from recovery in chip producing process and/or film producing process, and the polyester resin composition obtained by adding pigment to the polyester resin obtained by adding the organic phosphorus compound such as phosphine oxide, phosphonate and phosphinate to the polyester resin having 0.5 to 1.0 of intrinsic viscosity.

In addition, for example, Patent document 3 discloses flame retardant polyester fiber obtained by melt-spinning the resin composition having 0.2 to 15% by mass of inorganic red phosphorus or resin coated inorganic red phosphorus, and 0 to 5% by mass of carbon black.

Further, for example, Patent document 4 discloses the flame retardant recycle polyester fiber in which the recycled polyester obtained by adding organic phosphorus compound into low molecular weight substance obtained by depolymerization of the recycle polyester and by re-polymerizing it, subsequently is spun.

Furthermore, for example, Patent document 5 discloses the flame retardant textile product to which ammonium polyphosphate containing substances coated with thermoplastic resin was contained in treatment process after spinning.

In addition, for example, Patent document 6 discloses flame retardant for after-processing of polyester based synthetic fiber including polyphosphate compound which have no effect for dyeability of dye.

Furthermore, for example, Patent document 7 reports that, in flame retardant composition using inorganic red phosphorus and ammonium polyphospate in combination, when 10% by mass of ammonium polyphospate is added in the presence of 6% by mass of inorganic red phosphorus, synergy effect for flame proofing is recognized in polyether-ester resin. In addition, there are many reports on the resin composition using inorganic red phosphorus and inorganic phosphorus-nitrogen based compound such as ammonium polyphosphate in combination, however, there is no report that significantly effective flame retardant fiber can be obtained by kneading inorganic hybrid type flame retardant using them in combination, and subsequently by spinning.

### PRIOR ART DOCUMENTS

### Patent Documents

Patent document 1:JP-A-2002-54026

Patent document 2:JP-A-2007-254905

Patent document 3:JP-A-2001-279073

Patent document 4:JP-A-2006-70419

Patent document 5:JP-A-2001-262466

Patent document 6:JP-A-2007-92243

Patent document 7:WO92/02731 Pamphlet

### SUMMARY OF INVENTION

### Problem to be Solved by the Invention

However, in a method using copolymerized polyester like Patent document 1, copolymerization process is needed, therefore, this method cannot be used when polymerization technology and polymerization equipment therefor cannot be possessed. In addition, it is known that when content of organic phosphorus compound becomes 50,000 ppm or more based on concentration of phosphorus atom, melting point of polymer decreases remarkably, not only properties of polymer is decreased, but also, spinnability and fiber strength are adversely affected. Further, when the polyester textile products after use are tried to used as recycling, removal of chemically bonded structural unit of organic phosphorus is very difficult by separation or degradation.

In a method of kneading and spinning organic phosphorus compound like Patent document 2, because, when content of organic phosphorus compound is contained much, intrinsic viscosity of polyester resin decreases, it is needed to use in the range of 10,000 to 30,000 ppm of concentration of phosphorus atom. In addition, preventive various measures such as using the polyester resin having high intrinsic viscosity by solid phase polymerization and the like, as raw material in combination, and shortening of residence time in spinning machine to prevent thermal degradation of polymer, are needed. In this case, when organic phosphorus compound having low molecular weight and low melting point is used, it becomes a cause of various troubles such as decrease of flame retardant performance by bleeding, adverse effect in spinning of yarn breakage etc., and decrease of physical property of fiber.

Further, when spinning is carried out by kneading method with using inorganic red phosphorus as flame retardant like Patent document 3, inorganic red phosphorus exhibits red color, thus, the obtained fiber exhibits red color. Therefore, when the fiber maintaining the appropriate flame retardancy, and being colored with various colors, is produced, excess of colorant is needed for achromatizing, so, there occurred a big problem in light resistance such as light deterioration of colorant caused by it.

In addition, when flame proofing is performed to the recycle polyester by using organic phosphorus compounds as a flame retardant like Patent document 2 and 4, it is needed to use the specific waste material in chip producing process and/or film producing process or the like as raw resin. In addition, in order to increase intrinsic viscosity of raw resin, extra processes such as solid phase polymerization before spinning, depolymerization and re-polymerization of collected recycle polyester are needed. Restriction to the use of such recycled raw material, and implementation of extra process are causes of high cost, thus, the value of recycle business is decreased, and it is a barrier against wide prevalence.

Furthermore, like Patent document 5 and 6, in a method for performing flame proofing treatment and dyeing treatment after spinning polyester fiber, there are various weak point such as cumbersome treatment and heterogeneous treatment, also, coarsening of the fiber texture, and reduction of flame retardancy and dyeability by washing. When the flame proofing treatment and dyeing treatment are heterogeneous, textiles having sufficient flame retardant effect and excellent stable color for long time cannot be obtained, troubles are occurred in safety and quality aspects when used. Particularly, when used as automobile interior material, binder and large amount of flame retardant are needed to use, therefore, it is one of the cause to increase the weight of automobile. In addition, when textile after use is reused, there is a problem of separation of different polymer used as a binder of flame retardant.

When flame retardant performance is expressed by adding flame retardant to resin composition by kneading method, it is needed to add sufficient amount of flame retardant to resin composition for obtaining the satisfied flame proofing. However, when large amount of flame retardant is added into raw resin composition, there occurs many undesirable phenomena such as a problem that yarn formation becomes difficult in melt-spinning step; a problem that flame retardant deposits on the fiber surface in melt-spinning step and stretching step; also, a problem that production efficiency is remarkably reduced by frequent occurrence of yarn breakage; and further, a problem that satisfied physical property of fiber cannot be obtained by damaging the original property of fiber resin component significantly. For example, when polyethylene terephthalate is melt-spun and the fiber is obtained by stretching to 4 times, diameter of unstretched yarn becomes 20 to 500 μm, and diameter of stretched yarn becomes 10 to 250 μm. Thus, since the fiber diameter is very thin, flame retardants used in kneading method are needed to have excellent properties not only flame proofing but also dispersion property to fiber resin component in spinning step, non-deposition property to the fiber surface, stretching property in stretching step.

Therefore, when resin composition including 16% by mass or more of the flame retardant like Patent document 7 is not molded to plastic like Patent document 7, but is produced to the flame retardant fiber by melt-spinning method using the method of kneading the flame retardant, it is forecasted that the problems such as no capability of yarn formation, remarkable reduction of productivity by frequent occurrence of yarn breakage, also deposition of flame retardant onto the fiber surface. Therefore, in the fiber obtained by melt-spinning of resin composition described in Patent document 7, synergetic effect of flame proofing based on the use of inorganic red phosphorus and ammonium polyphosphate cannot be expected.

Therefore, the method of providing easily flame proofing to the polyester fiber which has the stable color for long time, and the excellent mechanical properties, particularly, resin composition necessary for flame retardant spun-dyed polyester fibers which can correspond to various kinds of products in small lots, have the excellent light resistance and durability, can be colored for various colors, and have environmentally-friendly property, and the method of providing the flame proofing to this composition are strongly desired.

On the other hand, such flame retardant spun-dyed polyester fibers have been used for the wide application such as curtains, carpets, bedclothes, tents, sheets, shrouds, disaster preventive hoods, clothes, upholstered furniture, interior material such as building, automobile, ship, airplane and etc.

As flame retardant, halogen type compounds such as bromine type, chlorine type and etc., besides organic phosphorus based compounds are widely used, however, problem is occurred in the combustion. That is, when substance using halogen type compound as flame retardant is combusted or incinerated, dioxins to be watched as environmental pollutant are generated.

In addition, the flame retardant material is required to have durability. Because of the excellent durability, disposal amount itself can be reduced, and evolution of carbon dioxide by incineration treatment can be efficiently suppressed. In addition, if the conventional resources can be reused at the same time, the material recycle of the object substances for incineration treatment becomes possible, and it can contribute to environment conservation, and can be economically advantageous. Particularly, if resources recovered by recent Containers and Packaging Recycling Law cannot be used efficiently, there is no meaning of recovery. Thus, from the viewpoint of environment conservation, there is strongly desired the versatile method for obtaining the flame retardant fiber easily by utilizing the conventional various resources.

### Means for Solving the Problem

The present inventors has investigated the combination of flame retardant, colorant, and thermoplastic polyester resin in detail, as a result, found that the well-balanced flame retardant spun-dyed polyester fiber having excellent spinnability, light resistance, and durability, being capable of coloring to various colors, being environmentally-friendly, and showing an excellent flame retardant effect, can be obtained by using the inorganic phosphorus-nitrogen based compound, in particular, polyphosphoric acid salt and/or phosphazenes, thus, has completed the present invention. That is, the present invention provides the below (1) to (11) items:

(1) A flame retardant spun-dyed polyester fiber obtained by melt-spinning a flame retardant polyester resin composition comprising a flame retardant including at least one inorganic phosphorus-nitrogen based compound selected from the group consisting of ammonium polyphosphate, melamine polyphosphate and phosphazenes, colorant, and thermoplastic polyester resin, characterized in that content of the inorganic phosphorus-nitrogen based compound is 0.1 to 12% by mass, content of the colorant is 0.01 to 5% by mass, and content of the thermoplastic polyester resin is 83 to 99.89% by mass, based on the total weight of the polyester resin composition.

(2) A flame retardant spun-dyed polyester fiber described in the above (1) obtained by melt-spinning a flame retardant polyester resin composition including a flame retardant including at least one inorganic phosphorus-nitrogen based compound selected from the group consisting of ammonium polyphosphate, melamine polyphosphate and phosphazenes, and inorganic red phosphorus, colorant, and thermoplastic polyester resin, characterized in that content of the inorganic phosphorus-nitrogen based compound is 0.1 to 8% by mass, content of the inorganic red phosphorus is 0.1 to 8% by mass, content of the above colorant is 0.01 to 5% by mass, and content of the thermoplastic polyester resin is 83 to 99.79% by mass, and also total of the content of the inorganic phosphorus-nitrogen based compound and the inorganic red phosphorus is 0.2 to 12% by mass based on the total weight of the polyester resin composition.

(3) The flame retardant spun-dyed polyester fiber described in the above (1) characterized in that the inorganic phosphorus-nitrogen based compound comprises at least one polyphosphoric acid salt selected from the group consisting of ammonium polyphosphate and melamine polyphosphate, and phosphazenes.

(4) The flame retardant spun-dyed polyester fiber described in any one of the above (1) to (3) characterized in that the inorganic phosphorus-nitrogen based compound is at least one polyphosphoric acid salt selected from the group consisting of ammonium polyphosphate and melamine polyphosphate, and a ratio of phosphorus atom not derived from polyphosphoric acid salt to phosphorus atom derived from polyphosphoric acid salt in the flame-retardant is 0.1 to 20 in phosphorous atom ratio.

(5) The flame retardant spun-dyed polyester fiber described in any one of the above (1) to (4), wherein decomposition temperature of the inorganic phosphorus-nitrogen based compound is 270° C. or more.

(6) The flame retardant spun-dyed polyester fiber described in any one of the above (1) to (5), wherein the polyester resin includes recycled polyester resin.

(7) The flame retardant spun-dyed polyester fiber described in any one of the above (1) to (6), wherein the colorant is at least one of the pigment selected from azo based, anthraquinone based, quinacridone based, cyanine based consisting of cyanine green and cyanine blue, dioxazine based, phthalocyanine based consisting of α-type phthalocyanine and β-type phthalocyanine, perinone based, perylene based, polyazo based, titanium yellow, ultramarine, iron oxide, Bengal red, zinc flower, titanium oxide based consisting of anatase type titanium oxide, rutile-type titanium oxide, and carbon based consisting of carbon black, graphite, spirit black, channel black and furnace black.

(8) The flame retardant spun-dyed polyester fiber described in any one of the above (1) to (7), wherein said fiber is obtained by melt spinning in which take-up speed by dry method is 300 to 1,000 m/min, and temperature of spinning is 200 to 300° C.

(9) A production method of the flame retardant spun-dyed polyester fiber described in any one of the above (1) to (8), characterized in that the inorganic phosphorus-nitrogen compound or master batch containing said inorganic phosphorus-nitrogen based compound; the inorganic red phosphorus or master batch containing said inorganic red phosphorus; master batch containing the colorant; and thermoplastic polyester resin are melt-blended, and subsequently, are melt-spun.

(10) A flame retardant material having 5 to 100% by mass of the flame retardant spun-dyed polyester fiber described in the above (1) to (8), or the flame retardant spun-dyed polyester fiber obtained from the production method described in the above (9).

(11) An automotive interior material in which the flame retardant material described in the above (10) is used.

### Effect of the Invention

According to the present invention, the flame retardant spun-dyed polyester fiber and flame retardant material excellent in spinnability, flame retardancy, colorability, light resistance, and durability by using inorganic phosphorus-nitrogen based compound as flame retardant can be obtained. In addition, the flame retardant fiber and flame retardant material excellent in light resistance, durability and being capable to color for various colors can be provided by kneading flame retardant and colorant together with polyester resin as raw material, and subsequently by melt-spinning. Furthermore, this application range can be enlarged by using the recycled polyester resin as raw material. In addition, when inorganic red phosphorus is used with the inorganic phosphorus-nitrogen based compound, particularly polyphosphoric acid salt in combination, decomposition of polyphosphoric acid salt and polyester resin can be suppressed in spinning, thus, resin composition for producing fiber having excellent spinnability and mechanical properties can be provided.

In addition, by using the environmentally-friendly inorganic phosphorus hybrid compound as flame retardant, the product having less environmentally hazardous product can be obtained even when product is treated as waste in the production step or after use. Separation of kneaded flame retardant is comparatively easy, and contamination of different kind of polymers used as a binder like flame proofing by after-treatment is not occurred, and can be easily re-cycled, therefore, amount of flame retardant to be used can be reduced. Particularly, in the sheet, carpet or the like for automobile interior, after-treatment processing is carried out by using flame retardant backing material. When the flame retardant fiber of the present invention is used, use of flame retardant backing material is not needed, consequently, this contributes to weight saving of automobile.

Particularly, when amount of flame retardant used in polyester resin composition increases, mechanical properties are decreased, and spinning becomes difficult in many cases. In the present invention, by using inorganic red phosphorus and inorganic phosphorus-nitrogen based compound as flame retardant, use amount of the flame retardant can be reduced, and by using master batch, compatibility of polyester and flame retardant is improved, and the stable resin composition can be obtained, and also, the polyester fiber excellent in mechanical properties can be obtained.

### MODE FOR CARRYING OUT THE INVENTION

The present invention is a flame retardant fiber characterized by obtained by melt-spinning a flame retardant polyester resin composition including a flame retardant including at least one inorganic phosphorus-nitrogen based compound selected from the group consisting of ammonium polyphosphate, melamine polyphosphate and phosphazenes, colorant, and thermoplastic polyester resin. And, in this flame retardant spun-dyed polyester fiber, based on the total weight of the above polyester resin composition, content of the above inorganic phosphorus-nitrogen based compound is 0.1 to 12% by mass, content of the above colorant is 0.01 to 5% by mass, and content of the above thermoplastic polyester resin is 83 to 99.89% by mass. It should be noted that, in the present invention, unless otherwise specified, numerical range represented as “to” means to contain both of upper limit and lower limit. For example, “0.1 to 8% by mass” means “0.1% by mass or more, and 8% by mass or less.

As the inorganic phosphorus-nitrogen compound used as the flame retardant of the present invention, polyphosphoric acid salt such as ammonium polyphosphate, melamine polyphosphate, and phosphazenes are represented. These may be used alone or in combination.

Ammonium polyphosphate used in the present invention is a compound represented as below general formula:

[Formula 1]

(NH₄PO₃)ₙ (1)

(wherein, n is an integer of 10 or more, preferably 300 or more, more preferably 500 or more, especially preferably 1,000 to 10,000), and is known 6 kinds of crystalline structure represented as I to VI type. In the present invention, any of these I to VI type ammonium polyphosphate can be used, but II type ammonium polyphosphate having high decomposition temperature is more preferable. One having 10 or more of polymerization degree (n) is preferable because its decomposition temperature is not significantly reduced. In addition, upper limit of polymerization degree (n) is not particularly limited, but when polymerization degree (n) becomes too large, it is not preferable because production becomes difficult, and also, trouble for the uniform dispersion into the fiber resin component is occurred due to many branching. Generally, ammonium polyphosphate is obtained by adding amide compound such as urea, and ammonium carbonate as dehydrating condensing agent or ammonization agent to phosphoric acid, ammonium phosphate or ammonium amidophosphate, and by reacting them.

It should be noted that, crystalline structure of ammonium polyphosphate is disclosed in some literatures. For example, I type to V type crystalline structures of ammonium polyphosphate are reported by C. Y. Shen et al. Journal of American Chemical Society, 91, p 62-67(1969). In addition, I type, II type, V type and VI type of ammonium polyphosphates are reported by Kjell R. Waestad et al., Journal of Agricultural and Food Chemistry, Vol. 24, No. 2, p 412-415(1978). Further, JP-A-2001-139315 reports, by X ray analysis of ammonium polyphosphates, strongest peak intensity is shown in 6.02 Å of lattice spacing as for I type, 5.70 Å of lattice spacing as for II type, 5.60 Å of lattice spacing as for V type, and 6.62 Å of lattice spacing as for VI type. And one having better crystalline property is preferable because it becomes to low solubility to water and the persistent properties. Among them, many research and development on the II type ammonium polyphosphate of persistent properties have been carried out.

For example, I type ammonium polyphosphate is relatively easily synthesized, but its crystallinity is low, and solubility in water is high. Consequently, synthetic method of II type ammonium polyphosphate having high crystallinity and low solubility in water is extensively researched. For example, a method that ammonia condensing agent such as amide compound, imide compound and ammonium carbonate is added to equimolar mixture of ammonium phosphate and diphosphorus pentaoxide, and is heated; a method that I type ammonium polyphosphate is heated under the atmosphere of dry air, subsequently, under the atmosphere of ammonia containing wet air to accomplish the phase transition to II type; a method that, using ammonium phosphate and ammonification condensing agent such as urea as raw material, II type ammonium polyphosphate is added as a seed compound therein, and is heated under the atmosphere of ammonia containing wet air, or the like is known.

Melamine polyphosphate to be used in the present invention means melamine adduct formed by reaction of melamine, and orthophosphoric acid, pyrophosphoric acid or polyphosphoric acid with substantially equimolar ratio. As production method of melamine polyphosphate, various methods such as a method of heating, calcining and condensing orthophosphoric acid; a method obtaining from polyphosphoric acid and melamine; a method obtaining from orthophosphoric acid and melamine; a method obtaining from melamine, ammonium polyphosphate and urea have been proposed, and are described in JP-A-2004-010649, JP-A-2004-155764 in detail. Among melamine polyphosphate, the reaction product with pyrophosphoric acid is particularly distinguished from others, and called as melamine pyrophosphate.

Further, as phosphazenes to be used in the present invention, any of the conventionally known compounds having phosphazene skeleton may be used without limitation. For example, at least one kind of phosphazene compound selected from the group consisting of cyclic phosphazene compound represented as the following general formula (2) and/or chained phosphazene compound represented as the following general formula (3) is included:

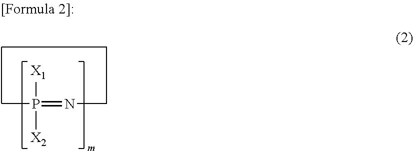

(wherein m is an integer of 3 to 25, X₁ and X₂ is each independently a substituent selected from the substituent represented by alkyl group having 1 to 6 carbon atoms, aryl group having 6 to 11 carbon atoms, fluorine atom, aryloxy group having 6 to 12 carbon atoms, naphthyloxy group, alkoxy group having 1 to 6 carbon atoms, and alkoxy substituted alkoxy group. It should be noted that, a part or all of hydrogen atoms on the substituent may be substituted with fluorine and/or a group having hetero elements. It should be noted that, the group having hetero elements is the group having B, N, O, Si, P or S atom, for example, the groups containing amino group, amido group, aldehyde group, glycidyl group, carboxyl group, hydroxy group, cyano group, mercapto group, silyl group or the like is included.)

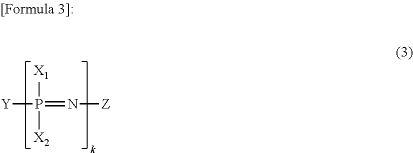

(wherein k is an integer of 3 to 1,000, X₁ and X₂ are the same as described above. Y represents −N═P(O) (X) or —N=P(X)₃, Z represents —P(X)₄ or —P(O) (X)₂. It should be noted that, X is the same as the above X₁).

Among these phosphazenes, straight chain compound having phenoxyphosphazene (in formula (3), X₁ and X₂=phenoxy group), propoxyphosphazene (in formula (3), X₁ and X₂=propoxy group), or diaminophosphazene (in formula (3), X₁ and X₂=amino group) as basic skeleton, and one having 10% by mass or more of phosphorus atom concentration is preferable. Particularly, phosphazenes have generally low melting point, low compatibility and/or low dispersibility with thermoplastic polyester resin, therefore, it is difficult to mix homogeneously in spinning, and the bleeding problem may be occurred. Therefore, the extreme attention such as using as master batch or using the other flame retardant in combination is needed.

The production method of these phosphazenes is not particularly limited, the conventionally known method may be used. For example, the above cyclic phosphazene compound and chained phosphazene compound can be produced from dichlorophosphazene compound according to the conventionally known method. Dichlorophosphazene compound can be produced by reacting ammonium chloride and phosphorus pentachloride (or ammonium chloride and phosphorus trichloride and chlorine) at approximately 120 to 130° C. to perform de-hydrochloric acid reaction, and purifying the reaction product.

As inorganic phosphorus-nitrogen based compound to be used in the present invention, all products obtained from the method described in the above known literature can be used, also, commercially available products can be used. The commercially available products include Teraju (product name; produced by Budenheim Iberica Co.), FR CROS (product name; produced by Budenheim Iberica Co.), Fire Cut P-770 and P-760 (product name; produced by Suzuhiro Chemical Co.), Pekoflam TC204 and TC-CS (product name; produced by Clariant Co.) M-PPA (trade name; produced by Sanwa Chemical Co.), Budit (product name; produced by Clariant Co.), Fire Cut CLMP (product name; produced by Suzuhiro Chemical Co.), cyclic phosphazene oligomer (product name; produced by Otsuka Chemical Co.), straight chained polyphosphazene (product name; produced by Otsuka Chemical Co.).

Decomposition temperature of inorganic phosphorus-nitrogen based compound to be used in the present invention can be determined by thermal analysis using differential scanning calorimeter, differential thermal analyzer, thermogravimetric measurement unit or the like. Specifically, decomposition temperature means a temperature at which 5% weight loss is occurred by gas evolution, also, means a cross point temperature of a base line in endothermic peak based on gas evolution corresponding thereto and a rising line of endothermic peak. Decomposition temperature of inorganic phosphorus-nitrogen compound to be used in the present invention is higher than melting point of thermoplastic polyester resin, generally, 250° C. or higher, particularly preferably 270° C. or higher. Upper limit of decomposition temperature is not particularly limited, generally, it is known that decomposition temperature increases with increased polymerization degree or crystallinity, therefore, one having high polymerization degree and excellent crystallinity is preferable.

Inorganic phosphorus-nitrogen compound to be used in the present invention is generally used as powder, and average diameter of powder is preferably 30 μm or less, more preferably, average diameter of the powder is 10 μm or less. When average diameter of powder is 30 μm or less, inorganic phosphorus-nitrogen based compound can be mixed with thermoplastic polyester resin as it is, and dispersed homogeneously, and dispersibility is improved with smaller particle diameter. Therefore, lower limit of average diameter of powder is not particularly limited. It should be noted that, uniform particle size distribution of the above powder is preferable, by sieving etc., by using the sieves of predetermined mesh size, for example, of 2 kinds of mesh size, powder which has narrow particle size distribution and is adjusted to uniform particle diameter, maybe used. In addition, particles coated with resin such as melamine, silicone on the surface of the inorganic phosphorus-nitrogen based compound can be used. By this method, compatibility with resin can be enhanced, particularly in case of polyphosphoric acid salt, hydrolysis and thermal decomposition can be retarded as well, and spinnability, flame proofing can be significantly improved.

Inorganic phosphorus-nitrogen based compound to be used in the present invention is generally colorless or white color powder, so it has not an adverse effect on coloring of textile product by colorant. In addition, as a functional group exerting the flame retardancy, it has not only inorganic phosphorus functional group, but also nitrogen functional group in combination, nitrogen functional group can express the flame retardant effect in which only the phosphorus functional group cannot exert, namely, can compensate the flame retardancy in which only the phosphorus compound cannot exert sufficiently.

Among the inorganic phosphorus-nitrogen based compound, polyphosphoric acid salt, particularly, ammonium polyphosphate has highest concentration of phosphorus atom, it is said that by synergetic effect with forming ammonia, ammonium polyphosphate has effective flame retardancy next to inorganic red phosphorus based on unit weight. However, among the inorganic phosphorus-nitrogen based compound, particularly, polyphosphoric acid salt is easily thermally decomposed and hydrolyzed, therefore, formed polyphosphoric acid acts as acidic catalyst, so, accelerates not only the decomposition of polyphosphoric acid salt, but also the decomposition of polyester of resin component, and has the significantly adverse effect on spinnability and physical properties of fiber. Thus, when such polyphosphoric acid salt is applied to textile product, it is easily decomposed by heat or water, and thermal history in the fiber production process is generated, so, extreme attention should be paid.

Consequently, when flame retardant contains polyphosphoric acid salt, it is preferable to use polyphosphoric acid salt and phosphazenes and/or inorganic red phosphorus in combination. By constituting flame retardant to such composition, adverse effect caused by the formation of polyphosphoric acid is alleviated, and the spinnability and physical properties of fiber are significantly improved. Therefore, excellent flame retardancy by polyphosphoric acid salt is provided, and the decomposition of polyphosphoric acid salt and polyester resin is significantly suppressed, so, application range can be widely enlarged.

As inorganic red phosphorus to be used in the flame retardant of the present invention, inorganic red phosphorus generally to be used as flame retardant for synthetic resin can be used. Generally, inorganic red phosphorus can be obtained in which yellow phosphorus is heat-treated in the reactor called as conversion kettle for several days to form massive solid, which is powderized by pulverization treatment. However, powderized red phosphorus obtained by such a treatment may be unstable for external stimuli such as heat, friction, impact, in some case. By physical, chemical surface treatment, or by using dispersant when red phosphorus is thermally converted from yellow phosphorus, powderized red phosphorus can be stabilized. In the present invention, all forms of the inorganic red phosphorus can be used. In order to obtain the stable flame retardant fiber, average diameter of inorganic red phosphorus powder is preferably 10 μm or less, and 80% by mass or more of inorganic red phosphorus powder is preferably composed of the particle having 20 μm or less of diameter. Further, inorganic red phosphorus is coated by resin, thus compatibility with thermoplastic polyester can be improved, and safety and stability in production, and reliability of textile product can be improved. As such resin coating method, the known method such as using the synthetic resin etc. can be used.

As the inorganic red phosphorus to be used in the present invention, any type obtained from the production method described in the above known literature can be used, and besides, commercially conventional products can be used. The commercially conventional products include Noburret (product name; produced by RIN KAGAKU KOUGYOU Co.), Hishiguard (product name; produced by NIPPON CHEMICAL INDUSTRIAL Co).

Inorganic red phosphorus used in the present invention has high concentration of phosphorus atom, and highest effect of flame retardant effect, but it is tinged with red color as itself, therefore, obtained textile product is also tinged with red color, and this red coloring becomes an obstacle to produce the various colored products. It is needed to achromatize by using colorant which has complementary color relationship with red, then, to color for coloring fiber with various color tone. Therefore, when much amount of inorganic red phosphorus is used to obtain higher flame retardancy, excess amount of colorant for achromaticity is needed to use, thus, increase of use amount of colorant causes the significant reduction of light resistance of textile product. Particularly, many of colorants having complementary color relationship with red color exhibit lower light resistance and high reactivity, further, it may be occurred that colorant interact with inorganic red phosphorus which is high reactive and is used in large amount. Consequently, if such colorant is used in large amount, it is a cause of significant decrease of light resistance.

As the excellent flame retardancy by inorganic phosphorus-nitrogen compound is provided in the flame retardant of the present invention, content of inorganic red phosphorus may be decreased or abolished totally. Therefore, the above problem caused by coloring of inorganic red phosphorus can be suppressed, consequently, light resistance of textile product can be improved.

As colorant to be used in the present invention, the known colorant such as organic pigment or inorganic pigment can be used. For example, organic pigment consisting of azo based, anthraquinone based, quinacridone based, cyanine based consisting of cyanine green and cyanine blue, dioxazine based, phthalocyanine based consisting of α-type phthalocyanine and β-type phthalocyanine, perinone based, perylene based, and polyazo based, inorganic pigment such as titanium oxide consisting of titanium yellow, ultramarine, iron oxide, Bengal red, zinc flower, titanium oxide based consisting of anatase type titanium oxide and rutile-type titanium oxide, and carbon based pigment consisting of carbon black, graphite, spirit black, channel black and furnace black, are included, however it is not particularly limited thereto. Generally, by selecting a plurality of adequate colorant from these colorants, and using the appropriate amount as the mixture, then, the flame retardant fiber can be colored with the desired color. In addition, by compounding the colorant directly to the resin composition as raw material, spun fiber can be provided with light resistance. Particularly, when it is used to the automotive interior material as the flame retardant material, light resistance is a very important factor because it always tends to be deteriorated with light.

Flame retardant and colorant are recognized as foreign substances in fiber, therefore, they significantly affect the yarn formation in the process of spinning and stretching, or physical properties of textile product. Particularly, much amount of flame retardant is needed to use in resin component to provide sufficient flame retardancy. Consequently, the effect of flame retardant is large, therefore, flame retardant to be used in flame proofing of fiber is needed a severe condition comparing with that of the molding of plastics, and is desired one having better flame retardant effect with the addition of small amount.

In addition, there are various different action mechanism in the flame retardant in burning, therefore, flame retardant action in gas phase and flame retardant action in solid phase are quite different. In gas phase, ones that discontinue the chain phenomena of burning, or reduce the concentration of oxygen necessary for burning, are preferred as flame retardants. On the other hand, in solid phase, ones that cover the surface of burning component by the char formation, or reduce thermal conductivity in burning by intumescent (expanded layer of surface) formation, are desired as flame retardants. Flame retardants of the present invention form char composed of phosphoric acid ester with network structure, and express the significant flame retardant effect. Further, inorganic phosphorus-nitrogen compound to be used in the present invention emits gas based on nitrogen component by the decomposition in burning. Consequently, excellent flame proofing can be accomplished by serving to the intumescent formation in solid phase to form excellent flame retardant, and also, by discontinuing the chain phenomena of burning, or reducing the concentration of oxygen, the excellent flame proofing can be attained. In addition, inorganic red phosphorus is not only excellent in the action of flame retardant action in solid phase, but also, can reduce the amount of oxygen around the material necessary for burning due to the easy reactivity with oxygen, thus, is excellent in the flame retardant action in gas phase.

Therefore, content of phosphorus and content of nitrogen in the flame retardant are important because they greatly affect the flame retardant performance. Content of phosphorus and content of nitrogen in the principal flame retardant components to be used in the present invention are shown below as theoretical value: 31.9% and 14.4% respectively in ammonium polyphosphate; 15.0 and 40.8% respectively in melamine polyphosphate; 14.4 and 39.1% respectively in melamine pyrophosphate; 13.4 and 6.1% respectively in phenoxyphosphazene; 19.0 and 8.6% respectively in propoxyphosphazene; 40.2 and 54.6% respectively in diaminophosphazene. In addition, inorganic red phosphorus is composed of only the phosphorus atom, so, content of phosphorus is 100%, content of nitrogen is 0%. Consequently, content of phosphorus in inorganic red phosphorus exhibits extraordinary high value, and is understood as flame retardant having excellent flame retardant effect. Next, diaminophosphazene, ammonium polyphosphate have high content of phosphorus, and exhibits excellent flame retardant effect. Particularly, ammonium polyphosphate is white powder and easy to handle, and balance of content of phosphorus and content of nitrogen is good, therefore, can be widely used as excellent flame retardant next to inorganic red phosphorus.

Flame retardant is required to disperse homogenously in resin components, and not to bring on the significant decomposition in the spinning process incurring considerable thermal history in addition to flame retardant performance. Acid component generated by decomposition functions as a catalyst of various reactions such as hydrolysis and thermal decomposition of ester compound, dehydration reaction, ester exchange reaction, consequently, it affects greatly the flame retardant even by small amount, thus, extreme attention should be paid for use. Therefore, in the selection of flame retardants, in addition to content of phosphorus and content of nitrogen, decomposition temperature, molecular weight, particle diameter, distribution of particle size, shapes (including the structural type such as straight chained, branched, and cross-linked type), and compatibility becomes important factor.

In addition, the flame retardant greatly affects for yarn formation in the process of the spinning and stretching. Consequently, as flame retardants, ones that have a excellent dispersibility to prevent deposition, protrusion, blooming, and breeding out onto the fiber surface, and have no solubility to the fiber resin component, and have no adverse effect by reacting with the fiber resin component, are expected. Therefore, in the yarn formation and physical properties of fiber, in addition to flame retardant performance, decomposition temperature, molecular weight, particle diameter, distribution of particle size, shapes (including the structural type such as straight chained, branched, and cross-linked type) and compatibility of flame retardant is important factor, and besides these items, further, stretching capability of in the process of spinning and stretching become important factors.

These factors may be a conflicting relationship each other in some cases. For example, ammonium polyphosphate has excellent flame proofing, but has less dispersibility to the fiber resin component, due to strong ionic structure of ammonium ion, compared with melamine polyphosphate, melamine pyrophosphate, phosphazenes. Thus, conflicting phenomena are frequently shown between factors affecting on the flame retardant performance and capability of yarn formation, or between the flame retardant performance and capability of yarn formation. Therefore, in the flame retardant of the present invention, it is preferable that a plurality of flame retardants are used in combination by utilizing the advantage of the own flame retardants rather than the single use of the flame retardant. By using a plurality of flame retardants in combination, desired results can be obtained in performance required for the above flame retardant, and the excellent flame retardant fiber can be obtained.

Next, the thermoplastic polyester resin to be used in the present invention is described. The thermoplastic polyester resin to be used in the present invention is not particularly limited, any type of polyester resin can be used regardless of the resin components if the resin is thermoplastic. In the present invention, by using inorganic phosphorus-nitrogen based compound, preferably by using polyphosphoric acid salt and inorganic red phosphorus and/or phosphazene in combination, it was found out that the significantly excellent flame retardancy can be provided to the spun-dyed polyester fiber. Therefore, the fiber can be obtained by spinning with using the obtained flame retardant spun-dyed polyester resin composition, and in this spinning, the known method can be used regardless of wet method or dry method for spinning. Also, limitation of thermoplastic polyester resin means that recycled polyester can be re-used if the resin is thermoplastic.

Such a dicarboxylic acid component composing the thermoplastic polyester resin includes terephtahlic acid, isophthalic acid, 2,6-naphthalene dicarboxylic acid, 1,5-naphthalene dicarboxylic acid, 4,4′-diphenyl dicarboxylic acid, bis-(4-carboxyphenyl) sulfone, bis(4-carboxyphenyl) ether, 1,2-bis(4-carboxyphenyl)ethane, 5-sodiumsulfoisophthalic acid, diphenyl-p,p′-dicarboylic acid, p-phenylene diacetic acid, and trans-hexahydroterephthalic acid, and alkylester, arylester, and ethylene glycol ester thereof. On the other hand, glycol component includes ethylene glycol, butylene glycol, 1,2-propylene glycol, 1,4-butanediol, trimethylene glycol, 1,6-hexanediol, 1,4-cyclohexanediol, neopentyl glycol, 1,4-cyclohexanedimethanol, and bisphenol A, and bisphenol S, and ethylene glycol, polyethylene glycol adducts thereof, and diethylene glycol and polyethylene glycol. Further, condensed type polyester resin of hydrocarboxylic acid like polylactides can be used. Among them particularly, as a thermoplastic polyester resin to be used in the present invention, polyethylene terephthalate and polybutylene terephthalate which can be used in much amount and can be obtained in cheap cost are preferable. In addition, these thermoplastic polyester resins may be used alone or in combination of a plurality of resin.

Number average molecular weight of the above thermoplastic polyester resin is not particularly limited, 1,000 to 100,000 is preferable, 5,000 to 50,000 is more preferable. In the case of 1,000 or more, it is possible to form yarn. In addition, in the case of 100,000 or less, melt-spinning is easy due to suppression of increase of viscosity. It should be noted that, the above number average molecular weight can be measured by using, for example, gel permeation chromatography (GPC). Generally, the above number average molecular weight can be replaced by intrinsic viscosity which can easily be measured. 0.05 to 2.53 is represented as intrinsic viscosity, preferably 0.19 to 1.40.

In addition, in the present invention, disposed waste after use as the thermoplastic polyester, or the mill end material in producing industrial products, can be used. That is, thermoplastic polyester resin in the present invention can contain recycled polyester resin. It should be noted that, in the present invention, disposed polyester resin widely includes the polyester resin other than the product, such as, the resin after use, or the resin which cannot be used as a product due to off-specification even before use. As such a disposed polyester resin, mill end material or less standard grade polyester resin disposed from synthetic fiber manufacturer, film manufacturer, pet-bottle manufacturer, polyester polymerization producer; and polyester resin obtained by Containers and Packaging Recycling Law of general waste, is exemplified. Thus, the waste material which is essentially disposed, or becomes target for incineration treatment can be subjected to material recycle, and contributes to environmental conservation, and is economically advantageous, as well.

In the flame retardant polyester resin composition to be used in the present invention, all of the flame retardant polyester resin maybe allowed to be such disposed polyester resin. Rather, when all of thermoplastic polyester resin is the used resin, waste material can be effectively used as raw material component, and material essentially for incineration can be used without incineration, therefore, the present invention can prevent evolution etc. of carbon dioxide and can contribute to environmental conservation.

In the flame retardant polyester resin composition to be used in the present invention, content of inorganic phosphorus-nitrogen compound is 0.1 to 12% by mass, preferably 0.5 to 8% by mass, more preferably 1 to 5% by mass, and content of colorant is 0.01 to 5% by mass, preferably 0.05 to 3% by mass, more preferably 0.1 to 2% by mass, and content of thermoplastic polyester resin is 83 to 99.89% by mass, preferably 89 to 99.45% by mass, more preferably 93 to 98.9% by mass based on total weight of polyester resin composition. When content of inorganic phosphorus-nitrogen based compound falls below 0.1% by mass or less, it becomes difficult to provide flame retardancy. In the other hand, when content of the inorganic phosphorus-nitrogen compound exceed 12% by mass or more, it becomes difficult to spin. Further, when content of colorant falls below 0.01% by mass or less, it is difficult to color textile product with various colors, and when content of colorant exceeds 5% by mass, it is a cause of deterioration of light resistance such as color change and is not preferable.

Further, when inorganic red phosphorus is contained, content of the inorganic phosphorus-nitrogen compound is 0.1 to 8% by mass, preferably 0.5 to 5% by mass, more preferably 1 to 4% by mass, content of inorganic red phosphorus is 0.1 to 8% by mass, preferably 0.5 to 5% by mass, more preferably 1 to 4% by mass. And total of the contents of inorganic phosphorus-nitrogen based compound and inorganic red phosphorus is 0.2 to 12% by mass, preferably 1.0 to 8% by mass, more preferably 2.0 to 5% by mass. Also, content of colorant is 0.01 to 5% by mass, preferably 0.05 to 3% by mass, more preferably 0.2 to 0.66% by mass, and content of thermoplastic polyester resin is 83 to 99.79% by mass, preferably 89 to 98.95% by mass, more preferably 94.34 to 97.8% by mass. When content of inorganic red phosphorus is 0.1% by mass and total of the contents of inorganic phosphorus-nitrogen compound and inorganic red phosphorus is 0.2% by mass or more respectively, it is possible to provide flame retardancy. On the other hand, when content of inorganic red phosphorus is 8% by mass or less, amount to be used of colorant for achromatizing red color to erase the red color can be reduced. In addition, when total of contents of inorganic phosphorus-nitrogen compound and inorganic red phosphorus is 12% by mass or less, spinning doses not become difficult.

In addition, when the flame retardant polyester resin composition contains polyphosphoric acid salt, ratio of phosphorus atom not derived from polyphosphoric acid salt to phosphorus atom derived from polyphosphoric acid salt in the flame retardant is 0.1 to 20 based on the ratio of phosphorus atom, preferably 0.3 to 15, more preferably 0.5 to 10. Here, “phosphorus atom derived from polyphosphoric acid salt” means phosphorus atom contained in polyphosphoric acid salt, and “phosphorus atom not derived from polyphosphoric acid salt” means phosphorus atom contained in the phosphorous-containing compound other than polyphosphoric acid salt. When ratio of phosphorus atom not derived from polyphosphoric acid salt to phosphorus atom derived from polyphosphoric acid salt is 0.1 or more and 20 or less, based on the ratio of phosphorus atom, decomposition of polyphosphoric acid salt and polyester resin can be suppressed. That is, by compounding inorganic phosphorus-nitrogen based compound, inorganic red phosphorus and colorant in the above range, into resin composition, the well-balanced flame retardant fiber having excellent flame retardancy, spinnability, and colorability for various colors can be obtained.

In the flame retardant resin composition to be used in the present invention, ratio of flame retardant and colorant, and polyester resin is enough to satisfy the above ratio. Also, in addition to this, the other additives can be further added in the range so as not to impair the spinnability and performance of fiber. Additives which may be included in flame retardants in the present invention include the other flame retardants such as aluminum hydroxide, magnesium hydroxide, antimony oxide, sodium carbonate and mixtures thereof. In addition, additives which can be included in the resin composition in the present invention include fire proofing agent such as calcium carbonate, talc; plasticizer such as phthalic acid ester, phosphoric acid ester, aliphatic acid ester; stabilizer such as inorganic acid salt, metallic soap; antioxidant such as alkylphenol, alkylenebisphenol; ultraviolet absorbing agent such as salicylic acid ester, benzotriazole, hydoroxybenzophenone, or the like.

In order to prepare the resin composition to be used in the present invention, it is preferable to use the flame retardant having the above inorganic phosphorus-nitrogen based compound and inorganic red phosphorus and master batch of the above colorant. For example, master batches containing the flame retardants and/or colorant in the master batch substrate are prepared in advance, then, both are mixed, subsequently, the thermoplastic polyester resin is melt-blended to the mixture to prepare the resin composition. To melt-mix the master batch and polyester resin, special method is not needed to be employed, the conventionally known method can be employed. For example, each of the chips before melt-mixing are mixed, then the mixture may be melted, also, both materials are melted separately, then, they may be mixed statically by using static mixer just before spinning. However, inorganic phosphorus-nitrogen based compound and/or inorganic red phosphorus can be melt-mixed without using the master batch. Particularly, when the resin-coated inorganic phosphorus-nitrogen based compound or inorganic red phosphorus is used, use of master batch is not especially needed, and can be directly melt-blended in polyester resin because the compatibility with polyester resin is excellent.

It should be noted that, when the master batch containing inorganic phosphorus-nitrogen based compound is used, the above inorganic phosphorus-nitrogen based compound preferably contains 5 to 70% by mass, more preferably 10 to 50% by mass in the master batch. When content is 5% by mass or more, use of master batch is meaningful because compounding amount of inorganic phosphorus-nitrogen based compound is sufficient, on the other hand, when this content is 70% by mass or less, preparation itself of master batch does not become difficult.

When the master batch containing inorganic red phosphorus is used, the above inorganic red phosphorus preferably contains 5 to 70% by mass, more preferably 10 to 50% by mass in the master batch. When content of inorganic red phosphorus is 5% by mass or more, use of master batch is meaningful because composition amount of inorganic red phosphorus is sufficient, further, when this content is 70% by mass or less, preparation itself of master batch does not become difficult.

As a substrate to be used in the master batch of inorganic phosphorus-nitrogen based compound and inorganic red phosphorus, any of resins which are thermoplastic resin, and do not lose the properties of the resin composition after compounded in polyester resin composition can be used without special limitation. Specifically, thermoplastic polyester resin and polypropylene based resin are preferable, among them, one including polyethylene terephthalate based polyester, polybutylene terephthalate based polyester as main components, polypropylene and ethylene-propylene block copolymer and the like are preferable. It should be noted that, commercially available products can be used for such master batch.

In addition, in the master batch of colorant, colorant is contained by 1 to 60% by mass, more preferably 10 to 35% by mass, especially preferably 20 to 30% by mass in the master batch. When content of the master batch of colorant is 1% by mass or more, desired color can be obtained by compounding the colorant . On the other hand, when content of the master batch of colorant is 60% by mass or less, the colorant can be mixed uniformly. As the resin to be used in the master batch, the same resin used for the inorganic phosphorus-nitrogen based compound and inorganic red phosphorus, namely, any resin which is thermoplastic resin, and does not lose the properties of the resin composition can be used without special limitation, thermoplastic polyester resin and polypropylene based resin can be used as most preferable resins.

It should be noted that, when the master batch of flame retardant and colorant are used as raw material of the flame retardant, spun-dyed polyester fiber in the present invention, it is preferable that each master batch is produced separately, then, is mixed in spinning. In many cases, flame retardants and colorant have high reactivity, thus, they tend to react each other, deteriorate, and change color at such high temperature and high concentration as to produce of master batch. Therefore, this is an obstacle for expressing the delicate color in the textile product, and becomes a cause of quality trouble in some case. In addition, as substrate to be used in master batch, it is preferable to use the same kind as the thermoplastic resin to be used in fiber as much as possible, and also single material, for the stable maintenance of the property of textile, and improvement of the recycling efficiency.

Further, the flame retardant spun-dyed polyester fiber can be obtained by fiberizing the above resin composition with the known melt-spinning method. In such case, cross-sectional shape may be optional, round cross-section fiber, modified cross-section fiber, or hollow fiber may be acceptable.

As method of melt-spinning, the known method can be used regardless of the wet method or dry method as the above, however, preferably in dry method, take-up speed is 300 to 1,000 m/min, and melt-spinning is preferably carried out at 200 to 300° C. of spinning temperature, and is carried out on optimum condition by varying adequately depending on yarn formation state. Particularly, as spinning temperature, it is preferable to set a plurality of temperatures to perform from the viewpoint of preventing the decomposition of the flame retardant in melt-spinning, and considering the decomposition temperature and thermal history of the inorganic phosphorus-nitrogen based compound, so as not to decompose significantly the inorganic phosphorus-nitrogen based compound contained in the flame retardant. Also, in the subsequent stretching process, the conventionally known stretching method can be used, and stretching is carried out at approximately 1.0 to 6.0 of stretching ratio.

The flame retardant spun-dyed polyester fiber in the present invention obtained by such a process can be used as fiber cotton such as staple fiber or filament, or can be used as felt only by compressing the fiber cotton, also, can be used as itself as flame retardant filler. In this case, fineness of the flame retardant spun-dyed polyester fiber in the present invention is preferably 1.0 to 660 decitex, more preferably 3.3 to 330 decitex, especially preferably 5.0 to 17.0 decitex. When fiber fineness is 1.0 decitex or more, occurrence of yarn breakage can be suppressed, on the other hand, when fiber fineness is 660 decitex or less, difficulty of fabrication due to rigidity is not occurred. In addition, such staple fiber or filament may be used alone or with the other fiber in combination to produce fabrics by weaving or knitting with the conventionally known method. For example, clothes may be obtained as sateen weave obtained by using the flame retardant spun-dyed polyester fiber yarn as weft, and on the other hand, the conventional white polyester stretched yarn as warp, or as double clothes obtained by constituting the flame retardant fiber yarn on one side of the surface.

Second aspect of the present invention is the flame retardant material having 5 to 100% by mass of the above flame retardant spun-dyed polyester fiber. The flame retardant material can be prepared by using the above flame retardant spun-dyed polyester fiber, or felt, clothes, fiber cotton consisting of the same. In this case, the flame retardant material contains 5 to 100% by mass of the flame retardant spun-dyed polyester fiber, more preferably 10 to 50% by mass, especially preferably 15 to 30% by mass. Flame retardant effect of the flame retardant spun-dyed polyester fiber in the present invention is big, therefore, when this material contains at least 5% by mass, this material can be efficiently used as the flame retardant material. Therefore, this material can be compounded to the conventional component to give flame retardancy, further, cost of product can be inexpensive because amount of composition is small, and the flame retardant effect can be provided without impairing drape of the conventional component.

The flame retardant material containing such flame retardant spun-dyed polyester fiber can be used, for example, as sheet to be used in the interior material of automotive; lining such as pillar garnish, rear parcel; floor lining such as matt, carpet; parts such as sun visor, package tray, assist grip; miscellaneous thermal insulating material; various sound insulating material; vibration-proofing material.

Third aspect in the present invention is the production method of the flame retardant spun-dyed polyester fiber characterized in that master batch containing inorganic phosphorus-nitrogen based compound or the inorganic phosphorus-nitrogen based compound, master batch containing inorganic red phosphorus or the red phosphorus, master batch containing colorant, and thermoplastic polyester resin are melt-mixed, subsequently, melt-spun.

Essentially, it is difficult to spinning to fiber by adding inorganic compound to polyester resin, particularly, yarn breakage trouble etc. occurred frequently due to insufficient compatibility of polyester resin and inorganic compound. However, in the present invention, additives can be easily homogeneously dispersed with the known melt-blending method by using master batch, consequently, spinning can be performed without yarn breakage. Particularly, the method of the present invention is characterized in that the conventional melt spinning method can be employed as it is even though inorganic based flame retardant such as inorganic phosphorus-nitrogen based compound and inorganic red phosphorus are compounded. Such melt-mixing method using master batch is the same method as described in preparation of resin composition of the present invention.

### EXAMPLE

Explanation is specifically given below according to Examples in the present invention.

### Example 1 to 8

Master batch containing ammonium polyphosphate (APP) 1 (produced by Clariant Co.; Product name: Pekoflam TC204; white powder; average particle diameter: 8 μm; content of phosphorus: 32% by mass; content of nitrogen: 15% by mass; polymerization degree: 1,000; decomposition temperature: 285° C.), inorganic red phosphorus, and colorant expressed as % by mass in Table-1; and polyethylene terephthalate (PET) resin 1 (produced by Mitsubishi Chemical Co.; Trade Name: “Novapex”) expressed as % by mass in Table-1 were melt-mixed by using extruder, and the flame retardant polyester resin compositions wherein the composition ratios were expressed in Table-1 were obtained respectively. Subsequently, these compositions were melt-spun by dry method wherein spinning speed was 520 m/min, temperature was 230 to 285° C., and the flame retardant staples (the flame retardant fiber 1 to 7) having 6.6 decitex of single yarn were obtained.

Except using the recycled PET resin (PET rein 2) having 0.65 of intrinsic viscosity obtained from disposed PET bottle and disposed PET film, instead of PET resin 1, the flame retardant staple (flame retardant fiber 8) was obtained from melt-spinning according to Example 4.

Spinnability of the flame retardant fiber 1 to 8 obtained in this way was evaluated. In addition, the test samples of flame retardant cotton were prepared, and flame retardancy, colorability, light resistance and mechanical properties (strength and elongation) of the same were evaluated. The results were shown in Table-1 as Example 1 to 8. It should be noted that, measurement method of spinnability, flame proofing, light resistance and mechanical properties (strength and elongation) were as follows:

(1) As for spinnability, in which 1 ton of fiber thread is spun to obtain the flame retardant spun-dyed polyester fiber yarn, spinnability was evaluated by the below criteria:

⊚ (excellent) □number of yarn breakage is below 5 times; ∘ (good) □number of yarn breakage is 5 times or more and less than 15 times; Δ (comp.bad): number of yarn breakage is 15 times or more; x(bad): spinning was not possible because normal yarn was not formed.

(2) Flame retardancy was evaluated according to the method described in JP-A-2001-279073. The flame retardant cottons obtained in advance left at 170±2° C. in thermostatic dryer for 10 minutes were used. As a test piece, 10 g of the unraveled flame retardant cottons were put uniformly and so as to have constant longitudinal length, into the total surface of basket made of stainless steel having 150 mm×100 mm×20 mm of size. In addition, when cotton was packed, air was blown lightly to the surface by dryer to obtain flat so that the fiber cotton is not pushed out from external shape, and test pieces was obtained. This test pieces was fixed horizontally at the position of 252 mm from installation stand so that rid side of test pieces was located downward. It should be noted that, mesh net was knitted by 0.2 to 0.4 mm Φ of aluminum wire to obtain 18 mesh net, upper lid was opened by arranging 2 windows having 65 mm×80 mm of size at traverse direction,

As fire source, Chakerman (Vesta Chakerman; manufactured by Tokai Co.) having sufficient fuel was used. Flame length was 50 mm, distance from ignition mouth to test pieces was 20 mm. Ignition was done approximately at the center of test pieces, after ignition, air around fire resource was left quietly, and was stood until completing burning. Flame was applied to test pieces for 10 seconds, then burning state was observed. Specifically, mean time from applying flame to ignition (second); mean time of burning from ignition (second: mean afterflame time) and maximum time (second: maximum afterflame time); maximum char length was measured and evaluated. 5 test pieces were used per 1 sample, and 2 points in each test pieces were evaluated. Therefore, the mean value represents the mean value per 10 measurements.

The longer the mean time until ignition is, the shorter the burning time is, and the shorter the char length is, the better the flame retardancy is. Particularly, the flame retardant having excellent flame retardant effect in gas phase is effective for mean time until ignition, and the flame retardant having excellent flame retardant effect in solid phase is effective for the burning time.

(3) Colorability was shown as numerical data by measuring L* value, a* value, and b* value of flame retardant cotton sample, using Spectrophotometric Colorimeter CM-3600d (manufactured by KONICA MINOLTA Co). L* value expresses brightness, a* value expresses axis of red-green, b* value expresses yellow-blue axis, data was represented as L*a*b* color system, and at the same time, color by visual observation was expressed. Here, a* value is represented as red color at plus side, green color at minus side, b* value is represented as yellow color at plus side, blue color at minus side, real color is represented as color space wherein L* value is z axis, a* value is x axis, b* value is y axis.

(4) Test pieces was left standing for 24 hours under 15 cm of distance from mercury light at ambient temperature, then light resistance was measured as ΔE*ab value represented as the below formula by using CM-3600d (manufactured by KONICA MINOLTA Co):

[Numerical Formula 1]

ΔE*ab=(Δa²+Δb²+ΔL²)^{1/2}

Wherein, Δa, Δb, ΔL means the difference vale of a*, b*, and L* before and after irradiation of mercury lamp, and the smaller ΔE*ab value is, the better the light stability is.

(5) Mechanical properties (strength and elongation) were measured by using desktop material testing machine STA-1150 (manufactured by ORIENTEC Co). 10 measurements were carried out per 1 sample. The larger the strength and elongation of fiber are, the better the mechanical properties of fiber are.

(6) Decomposition temperature was measured by using DSC equipment, and decomposition temperature is defined as cross point of base line in endothermic peak according to gas evolution and rising line of endothermic peak, and catalogue data was employed when no measuring data was obtained.

(7) Relative viscosity n of the solution in which 8 g of polyethylene terephthalate sample was dissolved in 100 ml of o-chlorophenol was measured by using Ostwald viscometer, then, intrinsic viscosity was calculated from the below approximate equation, and obtained intrinsic viscosity has an relationship with number averaged molecular weight according to the below viscosity equation.

[Numerical Formula 2]

Intrinsic viscosity=0.0242η+0.2634

[Numerical Formula 3]

Intrinsic viscosity=0.000127×[Number Average Molecular Weight]^{0.86}

TABLE 1

| | Example 1 | Example 2 | Example 3 | Example 4 | Example 5 | Example 6 | Example 7 | Example 8 |
|---|---|---|---|---|---|---|---|---|
| PET resin 1 | 98.85 | 97.34 | 94.38 | 94.39 | 92.38 | 92.38 | 89.90 | 0 |
| (% by mass) | | | | | | | | |
| PET resin 2 | 0 | 0 | 0 | 0 | 0 | 0 | 0 | 94.39 |
| (% by mass) | | | | | | | | |
| APP 1 (produced by | 0.20 | 1.00 | 2.00 | 3.00 | 4.00 | 3.00 | 10.00 | 3.00 |
| Clariant Co.) | | | | | | | | |
| (% by mass) | | | | | | | | |
| Total of Inorganic phosphorus- | 0.20 | 1.00 | 2.00 | 3.00 | 4.00 | 3.00 | 10.00 | 3.00 |
| nitrogen | | | | | | | | |
| compound (% by mass) | | | | | | | | |
| Inorganic red phosphorus | 0.30 | 1.00 | 3.00 | 2.00 | 3.00 | 4.00 | 0 | 2.00 |
| (% by mass) | | | | | | | | |
| Total of Flame | 0.50 | 2.00 | 5.00 | 5.00 | 7.00 | 7.00 | 10.00 | 5.00 |
| Retardant | | | | | | | | |
| (% by mass) | | | | | | | | |
| Ratio of phosphorus | 4.7 | 3.1 | 4.7 | 2.1 | 2.3 | 4.2 | 0 | 2.1 |
| atom* | | | | | | | | |
| Carbon black | 0.05 | 0.05 | 0.10 | 0.10 | 0.10 | 0.10 | 0.10 | 0.10 |
| (% by mass) | | | | | | | | |
| Rutile type | 0.50 | 0.50 | 0.50 | 0.50 | 0.50 | 0.50 | 0 | 0.50 |
| titanium oxide | | | | | | | | |
| (% by mass) | | | | | | | | |
| Cyanine green | 0.01 | 0.01 | 0.05 | 0.05 | 0.05 | 0.05 | 0 | 0.05 |
| (% by mass) | | | | | | | | |
| Titanium yellow (% | 0.10 | 0.10 | 0 | 0 | 0 | 0 | 0 | 0 |
| by mass) | | | | | | | | |
| Total of colorant | 0.66 | 0.66 | 0.65 | 0.65 | 0.65 | 0.65 | 0.10 | 0.65 |
| (% by mass) | | | | | | | | |
| Capability of | Excellent | Excellent | Excellent | Excellent | Good | Excellent | Comp. | Excellent |
| spinning | | | | | | | bad | |
| Flame retardant performance | | | | | | | | |
| Time until ignition | 4.02 | 4.15 | 7.74 | 7.23 | 8.50 | 9.24 | 9.02 | 7.55 |
| (sec) | | | | | | | | |
| mean afterflame | 3.82 | 1.20 | 0.50 | 0.55 | 0.30 | 0.11 | 0.68 | 0.89 |
| time (sec) | | | | | | | | |
| maximum afterflame | 8.40 | 4.03 | 1.30 | 1.44 | 1.05 | 0.88 | 1.58 | 1.67 |
| time (sec) | | | | | | | | |
| Length of char (mm) | 62 | 51 | 44 | 45 | 43 | 41 | 44 | 48 |
| Colorability | Beige | Beige | Glay | Glay | Glay | Glay | Glay | Glay |
| by visual test | | | | | | | | |
| L* | 42.1 | 40.8 | 33.0 | 33.9 | 33.5 | 32.8 | 36.6 | 34.2 |
| a* | 0.18 | 0.48 | 0.86 | 0.62 | 0.92 | 1.21 | 0.13 | 0.59 |
| b* | 12.37 | 11.15 | 4.30 | 4.41 | 4.26 | 4.06 | 4.91 | 3.92 |
| Light resistance ΔE* | 1.05 | 1.22 | 1.68 | 1.50 | 1.71 | 2.12 | 1.29 | 1.56 |
| ab | | | | | | | | |
| Mechanical Property: | 3.03 | 2.65 | 2.42 | 2.48 | 2.40 | 2.39 | 2.31 | 2.39 |
| Strength | | | | | | | | |
| (cN/dtex) | | | | | | | | |
| Mechanical Property: | 80 | 72 | 42 | 43 | 40 | 40 | 45 | 41 |
| Elongation (%) | | | | | | | | |

*In the table, ratio of phosphorus atom means the ratio of phosphorus atom not derived from polyphosphoric acid salt to phosphorus atom derived from polyphosphoric acid salt (mass ratio).

### Example 9 to 14

Spinning was carried out according to Example 1, except using ammonium polyphosphate (APP) 2 (produced by Budenheim Co.; product name: Teraju C-30; white powder; average particle diameter: 10 μm; content of phosphorus: 32% by mass; product coated by melamine; decomposition temperature: 305° C.); ammonium polyphosphate (APP) 3 (produced by Suzuhiro Chemical Co.; product name: Fire Cut 760; white powder; average particle diameter: 8 μm; content of phosphorus: 32% by mass; decomposition temperature: 205° C.); melamine polyphosphate (produced by Sanwa Chemical Co.; product name: MPP-A; white powder; average particle diameter: 4 μm; content of phosphorus: 15% by mass; decomposition temperature: 320° C.); melamine pyrophosphate (produced by Suzuhiro Chemical Co.; product name: Fire Cut CLMP; white powder; content of phosphorus: 15% by mass; content of nitrogen: 38% by mass; average particle diameter: 10 μm; decomposition temperature: 310° C.); polyphenoxyphosphazene (Otsuka Chemical Co.; product name: phosphazene; content of phosphorus: 13% by mass; decomposition temperature: 350° C. or more), expressed as % by mass in the Table-2, instead of ammonium polyphosphate (APP) 1 to obtain the flame retardant staple (the flame retardant fiber 9 to 14). On these flame retardant fiber 9 to 14, spinnability, flame retardant performance, colorability, light resistance and mechanical properties (strength and elongation) were evaluated in similar way as in Example 1, and results thereof were shown as Example 9 to 14 in Table-2

TABLE 2

| | Exmaple 9 | Exmaple 10 | Exmple 11 | Example 12 | Example 13 | Example 14 |
|---|---|---|---|---|---|---|
| PET resin 1 (% by mass) | 91.38 | 92.38 | 92.38 | 92.38 | 92.38 | 91.80 |
| APP2 (produced by Budenheim | 4.00 | | | | | |
| Co.) (% by mass) | | | | | | |
| APP3 (produced by Suzuhiro | | 4.00 | | | | 4.00 |
| Chemical Co.) | | | | | | |
| (% by mass) | | | | | | |
| Melamine polyphosphate | | | 4.00 | | | |
| (% by mass) | | | | | | |
| Melamine pyrophosphate | | | | 4.00 | | |
| (% by mass) | | | | | | |
| Polyphosphazene | | | | | 4.00 | 4.00 |
| (% by mass) | | | | | | |
| Total of inorganic | 4.00 | 4.00 | 4.00 | 4.00 | 4.00 | 8.00 |
| phosphorus-nitrogen compound | | | | | | |
| (% by mass) | | | | | | |
| Inorganic red phosphorus (% by | 3.00 | 3.00 | 3.00 | 3.00 | 3.00 | 0 |
| mass) | | | | | | |
| Total of flame retadant | 7.00 | 7.00 | 7.00 | 7.00 | 7.00 | 8.00 |
| (% by mass) | | | | | | |
| Ratio of phosphorus atom* | 2.3 | 2.3 | 5.0 | 5.0 | — | 0.4 |
| Carbon black (% by mass) | 0.10 | 0.10 | 0.10 | 0.10 | 0.10 | 0 |
| Rutile titanium oxide | 0.50 | 0.50 | 0.50 | 0.50 | 0.50 | 0.20 |
| (% by mass) | | | | | | |
| Cyanine green (% by mass) | 0.05 | 0.05 | 0.05 | 0.05 | 0.05 | 0 |
| Total of colorant | 0.65 | 0.65 | 0.65 | 0.65 | 0.65 | 0.20 |
| (% by mass) | | | | | | |
| Spinnability | Good | Good | Excellent | Excellent | Excellent | Good |
| Flame retardant performance | | | | | | |
| Time until ignition | 8.43 | 8.33 | 8.70 | 8.63 | 7.62 | 6.01 |
| (sec) | | | | | | |
| mean afterflame time (sec) | 0.32 | 0.35 | 0.22 | 0.27 | 0.48 | 0.70 |
| maximum afterflame time (sec) | 1.08 | 1.20 | 1.33 | 1.24 | 1.55 | 1.92 |
| Length of char (mm) | 44 | 46 | 44 | 42 | 45 | 47 |
| Clorability by | Glay | Glay | Glay | Glay | Glay | White |
| visual test | | | | | | |
| L* | 36.8 | 36.5 | 35.0 | 35.9 | 35.5 | 86.6 |
| a* | 0.88 | 0.97 | 0.93 | 0.91 | 0.90 | −0.19 |
| b* | 4.56 | 4.61 | 4.53 | 4.57 | 4.64 | 2.89 |
| Light resistance ΔE * ab | 2.15 | 2.23 | 2.01 | 1.96 | 2.03 | 2.08 |
| Mechanical properties Strength | 2.37 | 2.35 | 2.42 | 2.40 | 2.43 | 2.38 |
| (cN/dtex) | | | | | | |
| Mechanical properties Elongation | 39 | 38 | 42 | 41 | 44 | 40 |
| (%) | | | | | | |

*In the above table, ratio of phosphorus atom means the ratio of phosphorus atom not derived from polyphosphoric acid salt to phosphorus atom derived from polyphosphoric acid salt (mass ratio).

### Comparative Example 1 to 6

Spinning was carried out according to Example 1, except using ammonium polyphosphate (APP) 1, ammonium polyphosphate (APP) 3, inorganic red phosphorus expressed as % by mass in the Table-3, to obtain the flame retardant staple (comparative flame retardant fiber 1 to 6). On these comparative flame retardant fiber 1 to 6, spinnability, flame retardant performance, colorability, light resistance and mechanical properties (strength and elongation) were evaluated in similar way as in Example 1, and results therof were shown as Comparative Example 1 to 7 in Table-3.

TABLE 3

| | Comp. Example 1 | Comp. Example 2 | Comp. Example 3 | Comp. Example 4 | Comp. Example 5 | Comp. Example 6 |
|---|---|---|---|---|---|---|
| PET resin 1 (% by mass) | 99.88 | 85.88 | 85.80 | 86.87 | 94.87 | 95.90 |
| APP1 (produced by Clariant Co.) | 0.02 | 10.00 | 4.00 | 8.00 | 0 | 0 |
| (% by mass) | | | | | | |
| APP3 (produced by Suzuhiro | 0 | 0 | 0 | 0 | 0 | 4.00 |
| Chemical Co.) | | | | | | |
| (% by mass) | | | | | | |
| Inorganic phosphorus- | 0.02 | 10.00 | 4.00 | 8.00 | 0 | 4.00 |
| nitrogen comopound | | | | | | |
| (% by mass) | | | | | | |
| Inorganic red phosphorus (% by | 0.05 | 4.00 | 10.00 | 5.00 | 5.00 | 0 |
| mass) | | | | | | |
| Total of flame retardant | 0.07 | 14.00 | 14.00 | 13.00 | 5.00 | 4.00 |
| (% by mass) | | | | | | |
| Ratio of phosphorus atom (% by | 7.8 | 1.3 | 7.8 | 2.0 | — | 0.0 |
| mass)*^{□} | | | | | | |
| Carbon black (% by mass) | 0.05 | 0.10 | 0.10 | 0.10 | 0.10 | 0.10 |
| Rutile titanium oxide | 0.50 | 0.50 | 0.50 | 0.50 | 0.50 | 0 |
| (% by mass) | | | | | | |
| Cyanine green (% by mass) | 0.001 | 0.05 | 0.12 | 0.06 | 0.06 | 0 |
| Titanium yellow | 0.10 | 0 | 0 | 0 | 0 | 0 |
| (% by mass) | | | | | | |
| Total of colorant (% by mass) | 0.651 | 0.65 | 0.72 | 0.66 | 0.66 | 0.10 |
| Spinnability | Excellent | Bad | Bad | Comp. | Excellent | Comp. |
| | | | | Bad | | Bad |
| Flame retardant performance | | | | | | |
| Time until ignition | 3.82 | — | — | No Ignition*^{□} | No Ignition*^{□} | 3.50 |
| (sec) | | | | | | |
| mean afterflame time (sec) | 5.82 | — | — | — | — | 6.32 |
| maximum afterflame time | 9.73 | — | — | — | — | 10.55 |
| (sec) | | | | | | |
| Length of char (mm) | 74 | — | — | — | — | 67 |
| Colorability by visual test | Beige | — | — | Glay | Glay | Glay |
| L* | 64.6 | — | — | 29.1 | 31.2 | 33.5 |
| a* | 0.14 | — | — | 1.72 | 1.61 | 0.12 |
| b* | 14.09 | — | — | 4.12 | 4.30 | 3.09 |
| Light resistance ΔE * ab | 2.61 | — | — | 5.21 | 4.96 | 2.32 |
| Mechanical Properties | 3.08 | — | — | 2.35 | 2.43 | 2.58 |
| Strength (cN/dtex) | | | | | | |
| Mechanical Properties | 81 | — | — | 43 | 30 | 50 |
| Elongation(%) | | | | | | |

*¹In the above table, ratio of phosphorus atom means the ratio of phosphorus atom not derived from polyphosphoric acid salt to phosphorus atom derived from polyphosphoric acid salt (mass ratio).
*²In the Table, “No Ignition” means that the hole opened by melting without ignition.

BY comparing Example 1 to 14 with Comparative Example 1 to 6, it was found that when amount to be used of inorganic phosphorus-nitrogen compound and red phosphorus becomes less, provision of flame proofing becomes difficult, on the other hand, when amount to be used of inorganic phosphorus-nitrogen compound and red phosphorus becomes much, spinnability becomes worse.

In addition, it was understood that when amount to be used of inorganic red phosphorus becomes much, amount to be used of colorant to achromatize red color becomes much, and interaction of colorant with inorganic red phosphorus tends to occur, thus, light resistance becomes worse, therefore, it was not desirable.

Further, in Example 10 and 14 in which ammonium polyphosphate (APP) 3 and inorganic red phosphorus or phosphazenes were used in combination, compared with Comparative Example 6 in which ammonium polyphosphate (APP) 3 (decomposition temperature: 250° C.) was used alone, spinnability and flame retardant performance were found to be excellent. It was estimated that, in Comparative Example 6, decomposition has been occurred due to the single use of ammonium polyphosphate (APP) 3 which has low decomposition temperature, and spinnability and flame retardant performance have been deteriorated. On the other hand, in the system in which polyphosphoric acid salt and inorganic red phosphorus or phosphazenes were used in combination, decomposition of polyphosphoric acid salt was suppressed, consequently, it was estimated that the flame retardant spun-dyed polyester fiber excellent in spinnability and flame retardant performance was obtained. It was understood that, in Example 1 to 13, spinnability improves by using polyphosphoric acid salt and inorganic red phosphorus in combination, also, by using inorganic red phosphorus of certain amount or less, and inorganic phosphorus-nitrogen compound, particularly, ammonium polyphosphate in combination, it was understood that the flame retardant spun-dyed polyester fiber excellent in spinnability and flame retardant performance, colorability, light resistance and mechanical properties is obtained.

### Example 15

To the flame retardant fiber 2, 6, 8, 10, 11 and 13 obtained in Example 2, 6, 8, 10, 11 and 13, the flame retarding untreated fiber (in the table, expressed as untreated fiber) was compounded by the ratio described in Table-4 to prepare the flame retardant cottons, which were called as the flame retardant materials 1 to 6. Flame proofing thereof was evaluated. It should be noted that, flame retarding untreated fiber is the untreated fiber into which polyester resin composition prepared with the similar method to Example 1, except that ammonium polyphosphate was not contained in the polyester resin composition, was spun. In evaluation of flame retardant performance of the flame retardant materials 1 to 6 (flame retardant cotton), the similar method as in Example 1 was employed. Results are shown in Table-4.

In addition, to the flame retardant fiber obtained in Comparative Example 1 (comparative flame retardant fiber 1), flame retarding untreated fiber was compounded by the ratio shown in Table-4 to prepare the flame retardant cotton according to the above flame retardant material 1, which was called as the comparative flame retardant material 1, and flame retardant performance thereof was evaluated, the result was shown in Table-4. In evaluation of flame retardant performance, the similar method as in Example 1 was employed.

Further, in Table-4, as commercially available fiber, HEIM (trade name) produced by TOYOBO Co., in which copolymerized polyester was used in resin composition for spinning, was called as comparative flame retardant fiber 2, in which flame retardant untreated fiber was compounded, and this was called as comparative flame retardant material 2, and flame retardant performance was evaluated, and the result was shown in Table-4.

TABLE 4

| | | | | | | | Comparative flame | |
|---|---|---|---|---|---|---|---|---|
| | Flame retardant material | | | | | | retardant material | |
| | 1 | 2 | 3 | 4 | 5 | 6 | 1 | 2 |
| Untreated fiber | 80 | 80 | 80 | 80 | 80 | 80 | 80 | 80 |
| (% by mass) | | | | | | | | |
| Flame retardant fiber 2 (% | 20 | | | | | | | |
| by mass) | | | | | | | | |
| Flame retardant fiber 6 (% | | 20 | | | | | | |
| by mass) | | | | | | | | |
| Flame retardant fiber 8 (% | | | 20 | | | | | |
| by mass) | | | | | | | | |
| Flame retardant fiber 10 | | | | 20 | | | | |
| (% by mass) | | | | | | | | |
| Flame retardant fiber 11 (% | | | | | 20 | | | |
| by mass) | | | | | | | | |
| Flame retardant fiber 13 | | | | | | 20 | | |
| (% by mass) | | | | | | | | |
| Comparative flame | | | | | | | 20 | |
| retardant fiber 1 | | | | | | | | |
| (% by mass) | | | | | | | | |
| Comparative flame | | | | | | | | 20 |
| retardant fiber 2 | | | | | | | | |
| (% by mass) | | | | | | | | |
| Flame retardant | | | | | | | | |
| performance | | | | | | | | |
| Time until ignition (sec) | 3.50 | 8.05 | 6.53 | 6.97 | 7.55 | 6.73 | 3.03 | 3.05 |
| mean afterflame time (sec) | 6.22 | 0.51 | 4.53 | 1.83 | 1.08 | 2.15 | 28.05 | 33.20 |
| maximum afterflame | 49.40 | 8.77 | 21.03 | 15.10 | 14.53 | 17.83 | 140.10 | 124.30 |
| time | | | | | | | | |
| (sec) | | | | | | | | |
| Length of char (mm) | 73 | 56 | 68 | 65 | 61 | 62 | 104 | 95 |

1. (canceled)

2. A flame retardant spun-dyed polyester fiber obtained by melt-spinning a flame retardant polyester resin composition comprising
a flame retardant comprising at least one inorganic phosphorus-nitrogen based compound selected from the group consisting of ammonium polyphosphate, melamine polyphosphate and phosphazenes, and inorganic red phosphorus;
colorant; and
thermoplastic polyester resin;
wherein the content of said inorganic phosphorus-nitrogen based compound is 0.1 to 8% by mass, the content of said inorganic red phosphorus is 0.1 to 8% by mass, the content of said colorant is 0.01 to 5% by mass, and the content of said thermoplastic polyester resin is 83 to 99.79% by mass, and
wherein the total of the content of said inorganic phosphorus-nitrogen based compound and said inorganic red phosphorus is 0.2 to 12% by mass based on the total weight of said polyester resin composition.

3. A flame retardant spun-dyed polyester fiber obtained by melt-spinning a flame retardant polyester resin composition comprising a flame retardant comprising
an inorganic phosphorus-nitrogen based compound consisting of at least one polyphosphoric acid salt selected from the group consisting of ammonium polyphosphate, melamine polyphosphate, and phosphazenes;
colorant; and
thermoplastic polyester resin;
wherein the content of said inorganic phosphorus-nitrogen based compound is 0.1 to 12% by mass, the content of said colorant is 0.01 to 5% by mass, and the content of said thermoplastic polyester resin is 83 to 99.89% by mass, based on the total of said polyester resin composition.

4. The flame retardant spun-dyed polyester fiber according to claim 2 wherein said inorganic phosphorus-nitrogen based compound comprises at least one polyphosphoric acid salt selected from the group consisting of ammonium polyphosphate and melamine polyphosphate, wherein the ratio of phosphorus atom not derived from polyphosphoric acid salt to phosphorus atom derived from poly-phosphoric acid salt in the flame-retardant is 0.1 to 20 in phosphorous atom ratio.

5. The flame retardant spun-dyed polyester fiber according to claim 2, wherein the decomposition temperature of said inorganic phosphorus-nitrogen based compound is 270° C. or more.

6. The flame retardant spun-dyed polyester fiber according to claim 2, wherein said thermoplastic resin comprises recycled polyester resin.

7. The flame retardant spun-dyed polyester fiber according to claim 2, wherein said colorant is selected from the group consisting of an azo based colorant, an anthraquinone based colorant, a quinacridone based colorant, a cyanine based colorant consisting of cyanine green and cyanine blue, a dioxazine based colorant, a phthalocyanine based colorant consisting of α-type phthalocyanine and β-type phthalocyanine, a perinone based colorant, a perylene based colorant, a polyazo based colorant, titanium yellow, ultramarine, iron oxide, Bengal red, zinc flower, a titanium oxide based colorant consisting of anatase titanium oxide and rutile titanium oxide, and a carbon based colorant consisting of carbon black, graphite, spirit black, channel black, and furnace black.

8. The flame retardant spun-dyed polyester fiber according to claim 2, wherein said fiber is obtained by melt spinning in which the take-up speed by dry method is 300 to 1,000 m/min, and the temperature of spinning is 200 to 300° C.

9. A method for producing the flame retardant spun-dyed polyester fiber according to claim 2, wherein the inorganic phosphorus-nitrogen based compound or master batch containing said inorganic phosphorus-nitrogen based compound; the inorganic red phosphorus or master batch containing said inorganic red phosphorus; master batch containing the colorant; and thermoplastic polyester resin are melt-blended, and subsequently, are melt-spun.

10. A flame retardant material containing 5 to 100% by mass of the flame retardant spun-dyed polyester fiber according to claim 2.

11. An automotive interior material comprising the flame retardant material according to claim 10.

12. The flame retardant spun-dyed polyester fiber according to claim 2, wherein said inorganic phosphorus-nitrogen based compound is a powder having an average diameter of less than or equal to 30 μm.

13. The flame retardant spun-dyed polyester fiber according to claim 2, wherein the thickness of said fiber is 1.0 to 17.0 decitex.

14. The flame retardant spun-dyed polyester fiber according to claim 2, wherein said phosphazenes are straight chained compounds with a backbone selected from the group consisting of phenoxyphosphazene, propoxyphosphazene, and diaminophosphazene.

15. The flame retardant spun-dyed polyester fiber according to claim 3, wherein said inorganic phosphorus-nitrogen based compound comprises at least one polyphosphoric acid salt selected from the group consisting of ammonium polyphosphate and melamine polyphosphate, wherein the ratio of phosphorus atom not derived from polyphosphoric acid salt to phosphorus atom derived from polyphosphoric acid salt in the flame-retardant is 0.1 to 20 in phosphorous atom ratio.

16. The flame retardant spun-dyed polyester fiber according to claim 3, wherein the decomposition temperature of said inorganic phosphorus-nitrogen based compound is 270° C. or more.

17. The flame retardant spun-dyed polyester fiber according to claim 3, wherein said thermoplastic resin comprises recycled polyester resin.

18. The flame retardant spun-dyed polyester fiber according to claim 3, wherein said colorant is selected from the group consisting of an azo based colorant, an anthraquinone based colorant, a quinacridone based colorant, a cyanine based colorant consisting of cyanine green and cyanine blue, a dioxazine based colorant, a phthalocyanine based colorant consisting of α-type phthalocyanine and β-type phthalocyanine, a perinone based colorant, a perylene based colorant, a polyazo based colorant, titanium yellow, ultramarine, iron oxide, Bengal red, zinc flower, a titanium oxide based colorant consisting of anatase titanium oxide and rutile titanium oxide, and a carbon based colorant consisting of carbon black, graphite, spirit black, channel black, and furnace black.

19. The flame retardant spun-dyed polyester fiber according to claim 3, wherein said fiber is obtained by melt spinning in which the take-up speed by dry method is 300 to 1,000 m/min, and the temperature of spinning is 200 to 300° C.

20. A method for producing the flame retardant spun-dyed polyester fiber according to claim 2, wherein the inorganic phosphorus-nitrogen based compound or master batch containing said inorganic phosphorus-nitrogen based compound; the inorganic red phosphorus or master batch containing said inorganic red phosphorus; master batch containing the colorant; and thermoplastic polyester resin are melt-blended, and subsequently, are melt-spun.

21. A flame retardant material containing 5 to 100% by mass of the flame retardant spun-dyed polyester fiber according to claim 3.
